(19) United States
(12) Patent Application Publication
(10) Pub. No.: US 2010/0103144 A1
(43) Pub. Date: Apr. 29, 2010

(54) METHOD AND APPARATUS FOR IMPROVED COMPUTER MONITORING PAD POINTING DEVICE

(76) Inventors: NARAYAN L. GEHLOT, Sayreville, NJ (US); VICTOR B. LAWRENCE, Holmdel, NJ (US)

Correspondence Address: WALL & TONG, LLP/;ALCATEL-LUCENT USA INC., 595 SHREWSBURY AVENUE, SHREWSBURY, NJ, 07702, US

(21) Appl. No.: 12/651,668

(22) Filed: Jan. 4, 2010

Related U.S. Application Data
(63) Continuation of application No. 10/638,128, filed on Aug. 8, 2003.

(51) Int. Cl. G06F 3/033; G08C 21/00

(52) U.S. Cl. 345/179; 178/18.03

(57) ABSTRACT

A monitoring pad assembly is provided for use with a graphical user interface including a monitoring pad and a signal assembly, at least one of which may be adapted to be worn on at least one of a user's digits, wherein movement of the signal assembly relative to the touch pad housing indicates a desired movement of the pointing device. Further embodiments of the invention provide a method for tracking an on-screen pointer, including the steps of: emitting a signal from a device adapted to be worn on at least one of a user's digits, and monitoring the movement and direction of the emitted signal.

### CROSS-REFERENCE TO RELATED APPLICATIONS

This application is a continuation of pending U.S. patent application Ser. No. 10/638,128, entitled METHOD AND APPARATUS FOR IMPROVED COMPUTER MONITORING PAD POINTING DEVICE, filed on Aug. 8, 2003, which application is incorporated herein by reference in its entirety.

### FIELD OF THE INVENTION

The present invention generally relates to the field of computers, and more particularly relates to a pointing device for a computer.

### BACKGROUND OF THE INVENTION

A pointing device for use with a computer is well known. Existing pointing devices, such as a mouse, combine tracking and selecting functions into one device. Tracking involves physically moving the mouse to control the motion of an on-screen pointer or other icon. Physical movement of the mouse is typically accomplished by moving the wrist and palm of the hand gripping the mouse. Once tracking has moved the pointer, an operation may be selected for execution by the computer, typically by depressing a button on the mouse.

A computer user relies significantly on his or her hand (particularly on the wrist, palm and fingers) to use a mouse for executing computer operations. Unfortunately, the use of a computer mouse over extended periods of time has been shown to be a leading cause of many different types of repetitive motion injuries (RMI) to body parts including the wrists, fingers, shoulders, and elbows, e.g. Carpal Tunnel Syndrome (CTS). Individuals in many fields of work rely on computers in their daily work and are thus forced to use a mouse quite extensively. Early injuries to children may even be incurable, rendering the injured child permanently disabled.

One common solution to this problem is a pressure-sensitive touch pad mouse such as that commonly built into laptop computers. A computer user moves his or her finger over the touch pad to control the movement of the pointer on screen, i.e., to track, and then clicks a button to execute, i.e., select, the desired operation. However, a frequent problem with such devices is that over periods of extended use, static charges may build up on the surface of the pad, causing the pad to erroneously sense a movement on the surface; in essence, the buildup of static causes the mouse to “run on its own”. This can lead to unwanted operations being executed or selected, such as the deletion of files.

### SUMMARY OF THE INVENTION

The problems of prior art pointing devices are overcome by a signal assembly adapted to be worn on at least one of a user's digits, for use in conjunction with a monitoring pad, the monitoring pad being operable so that movement of the signal assembly relative to the monitoring pad indicates a desired movement of the pointing device which may be shown to a user of a graphical user interface. In exemplary embodiments of the invention, the monitoring pad may be incorporated into a desktop or laptop computer, and a signal assembly used in conjunction with the monitoring pad may be adapted to be worn on at least one of a user's digits, or a device adapted to be held in a user's hand. Embodiments of the invention allow a user to operate a pointing device with several different body parts, thereby alleviating repeated stress to any single appendage, and also provide a more precise and reliable pointing device.

### BRIEF DESCRIPTION OF THE DRAWINGS

FIG. 1 is a split perspective and cross-sectional view of one embodiment of a touch pad assembly according to the present invention;

FIG. 2 is a flow diagram illustrating the algorithm by which one embodiment of a touch pad assembly the present invention tracks an on-screen pointer;

FIG. 3 is a graph visually illustrating the function of one embodiment of a touch pad assembly of the present invention;

FIG. 4 is a split perspective and cross-sectional view of a second embodiment of a touch pad assembly according to the present invention;

FIG. 5 is a split perspective and cross-sectional view of a third embodiment of a touch pad assembly according to the present invention;

FIG. 6 is a split perspective and cross-sectional view of a fourth embodiment of a touch pad assembly according to the present invention;

FIG. 7 is a split perspective and cross-sectional view of a fifth embodiment of a touch pad assembly according to the present invention;

FIG. 8 is a split perspective and cross-sectional view of a sixth embodiment of a touch pad assembly according to the present invention; and

FIG. 9 is a split perspective and cross-sectional view of a seventh embodiment of a touch pad assembly according to the present invention.

To facilitate understanding, identical reference numerals have been used, where possible, to designate identical elements that are common to the figures.

### DETAILED DESCRIPTION

The present invention provides an improved monitoring pad assembly for reducing the occurrence of repetitive motion injuries in a computer user. This aim is accomplished by a monitoring pad that is operated by a digit-worn device comprising an optical or heat sensor, rather than a pressure sensor as in conventional touch pad designs. In one embodiment, the monitoring pad is built into a computer device or is an external stand-alone device linked to a processor. In another embodiment, the monitoring pad is incorporated into a digit-worn device. In yet another embodiment, the monitoring pad may be incorporated into a hand-held device. In several embodiments, the monitoring pad assembly may additionally incorporate a selecting device, so that all conventional mouse functions may be executed by one device.

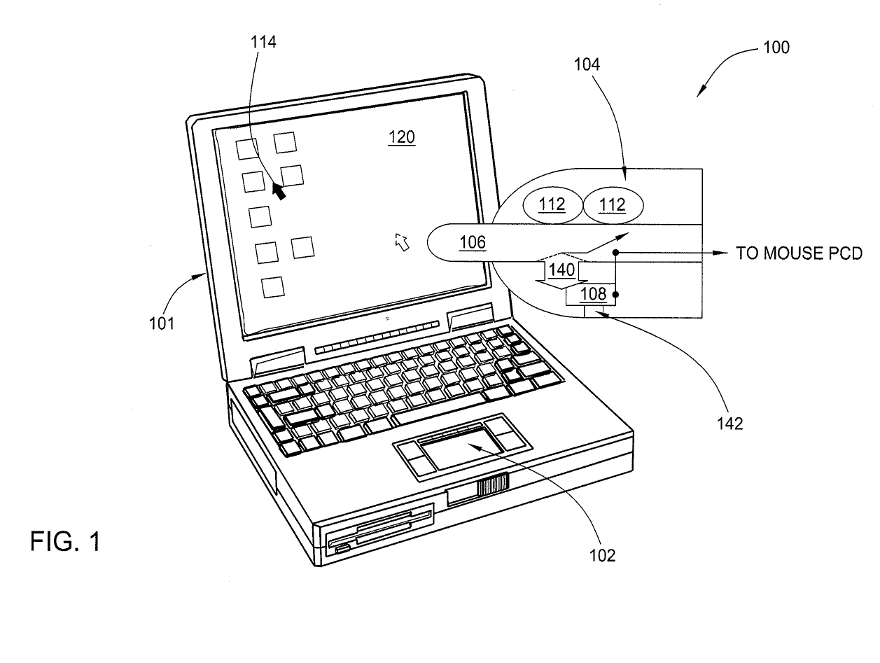

FIG. 1 illustrates one embodiment of the present invention, in which a monitoring pad assembly 100 includes an integrated circuit (IC) pad 102 and a signal assembly 104 adapted to be worn over at least one of a user's digits 106.

The monitoring pad assembly 100 includes a signal assembly 104 adapted to be worn over at least one of a user's digits 106. A light emitting diode (LED) 108 is built into the signal assembly 104. The signal assembly 104 optionally further includes a grin lens 142 adapted to collimate the optical output of the LED 108 and narrow a beam emitted therefrom (for example, to approximately as narrow as ten micrometers). The narrower the beam, the higher the resolution per square inch of optical pad 102. The signal assembly 104 further includes a power source such as at least one button battery 112 to provide electrical power to the LED 108. In one embodiment, the power source provides between three and five volts.

The IC pad 102 is an optical monitoring pad, and in one embodiment it is adapted to be integrated into a computer, for example, in place of a conventional touch pad on a laptop computer 101. However, in further embodiments, the optical pad 102 may be configured as an external stand-alone device linked to the processor via RF for remote use. One example of an optical sensor that may be advantageously adapted for use with the optical monitoring pad 102 of the present invention is the HDNS-2000 commercially available from Agilent Technologies of Palo Alto, Calif.

When the LED 108 is brought into physical contact with the optical monitoring pad 102, the weight of the digit 106 on which the signal assembly 104 is worn activates a spring switch 140 in the signal assembly 104, activating the LED 108 and causing the LED 108 to emit a beam of light. Conversely, when the user's digit 106 is removed from the monitoring pad 102, the weight of the LED 108 is shifted off of the spring switch 140, breaking the circuit that activates the LED 108 and causing the LED 208 to shut off to save battery power.

The optical monitoring pad 102 includes a digital signal processor (DSP) (not shown) that converts incremental position changes of the emitted beam of light between a first touch point and a second touch point into distance (ΔX and ΔY) and direction [tan⁻¹ (ΔY/ΔX)] outputs. Thus as the beam of light is sensed and monitored by the optical pad 102, the on screen pointer 114 is moved according to the movement of the user's digit 106.

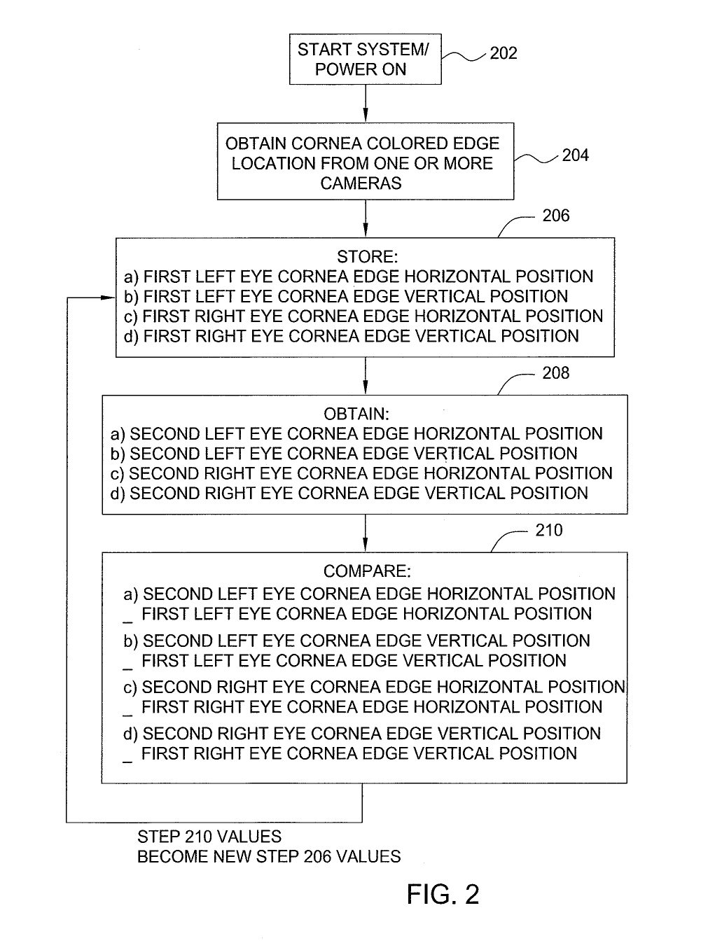

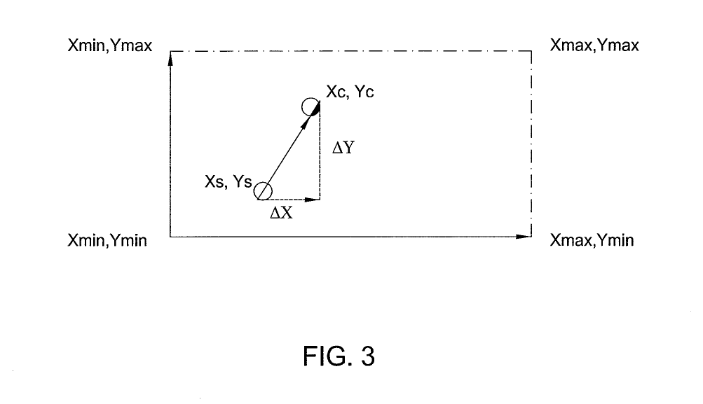

The algorithm by which the DSP carries out this process is detailed in FIG. 2. As illustrated, once the optical pad 102 is enabled by contact with the signal assembly 104, the IC locates the initial position of the beam on the surface of the pad 102 and stores its coordinates (Xs, Ys) as a reference point. The beam is then moved across the pad 102 as the user moves his or her digits(s) 106, and the IC identifies the coordinates of the second (“current”) position of the beam on the pad surface (Xc, Yc). The incremental differences (ΔX and ΔY) in the coordinates between the second (Xc, Yc) and initial (Xs, Ys) stored positions are computed. The on screen pointer 114 is moved according to the indicated differentials in position (see FIG. 3), and the coordinates of the current (second) position are stored as the next reference point.

FIG. 3 also indicates how to map monitor screen pixels to the optical power detection area of the pad 102 so that movement of the pointer 114 translates smoothly and accurately from the pad 102 to the screen 120. The range of horizontal movement is bounded by two values, Xmin and Xmax, where Xmin represents the minimum horizontal position on the optical pad 102 and Xmax indicates the maximum horizontal position. Similarly, the range of vertical movement is bounded by two values, Ymin and Ymax, where Ymin represents the minimum vertical position on the optical pad 102 and Ymax indicates the maximum vertical position.

Therefore, once the monitoring pad assembly 100 has properly oriented the pointer 114 on-screen, the computer user may indicate selection of an operation, for example, by depressing a button on a laptop computer. Because tracking and selecting are done by several digits over a small area, the wrist is minimally involved the use of the monitoring pad assembly 100 and is thus strained to a substantially lesser extent than in the use of a conventional mouse. Furthermore, problems caused by static charges built up on conventional touch pads are substantially eliminated by the use of a monitoring pad assembly 100 that works by operation of an optical, rather than pressure, sensor. It will also be appreciated that the simplicity of the monitoring pad assembly design allows the signal assembly to be worn on a digit of either hand, or even a foot, making the design suitable for left- or right-handed use without modification or manufacturing alteration.

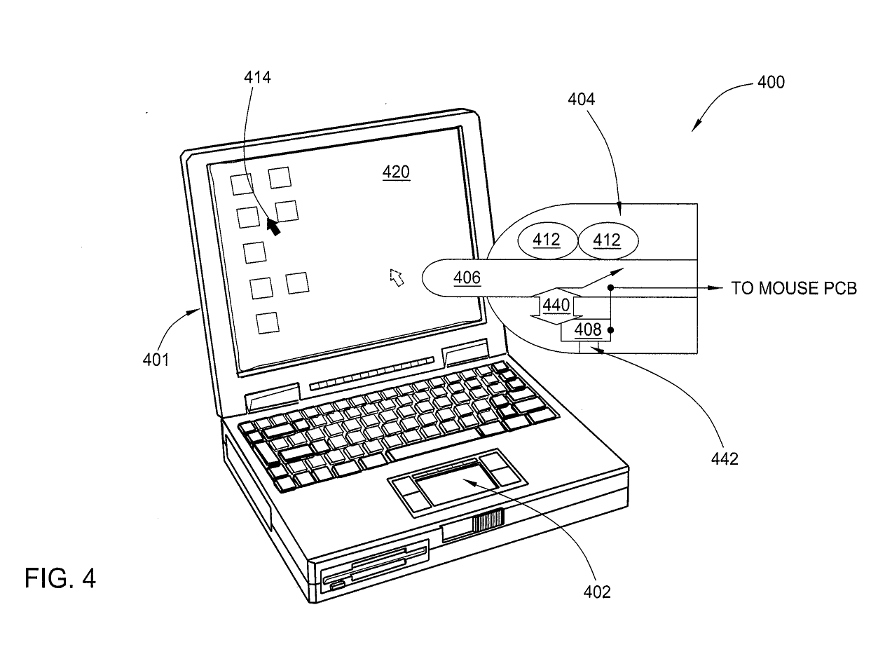

In a second embodiment, illustrated in FIG. 4, the IC pad 402 is a temperature monitoring pad, and the signal assembly 404 incorporates a Body Temperature Tip (BTT) 408 rather than an LED. In one embodiment the temperature monitoring pad 402 is adapted to be integrated into a computer, for example, in place of a conventional touch pad on a laptop computer 401. However, in further embodiments, the temperature pad 402 may be configured as an external stand-alone device linked to the processor via RF for remote use.

Temperature sensors that may be advantageously adapted for use with the BTT 408 the present invention include, but are not limited to, the TMP03 and TMP04 integrated circuits commercially available from Analog Devices of Norwood, Mass. One example of a mouse controller that may be advantageously adapted for use with this and similar embodiments of the present invention is the HT6523 commercially available from Holtek Semiconductor, Inc. of Shanghai, China. The signal assembly 404 optionally further includes a fine tip 442 adapted to collimate temperature output and narrow the temperature contact to the IC pad 402 for greater resolution per square inch. The signal assembly 404 further includes a power source such as at least one button battery 412 to provide electrical power to the BTT 408. In one embodiment, the power source provides between three and five volts.

When the BTT 408 is brought into physical contact with the temperature monitoring pad 402, the weight of the digit 406 on which the signal assembly 404 is worn activates a spring switch 440 in the signal assembly 404, activating the BTT 408 and causing the BTT 408 to emit a temperature signal that emanates from the user (i.e., via body heat). Conversely, when the user's digit 406 is removed from the monitoring pad 402, the weight of the BTT 408 is shifted off of the spring switch 440, breaking the circuit that activates the BTT 408 and causing the BTT 408 to shut off to save battery power.

The temperature pad 402 includes a digital signal processor (DSP) that converts incremental position changes of the emitted temperature signal between a first touch point and a second touch point into distance (ΔX and ΔY) and direction [tan⁻¹ (ΔY/ΔX)] outputs. The algorithm by which the DSP carries out this process is identical to that illustrated in FIG. 2. As the temperature signal is sensed and monitored by the temperature pad 402, the on-screen pointer 414 is moved according to the movement of the user's digit(s) 406. The DSP may optionally consist of a separate core built into the temperature pad 402. The temperature sensors in the temperature monitoring pad 402 may be calibrated to a certain body temperature percentage, so that they are activated only by a signal that meets or exceeds a pre-set temperature. Therefore, inadvertent activation of the monitoring pad assembly 400 may be avoided.

The output of the mouse controller is directly compatible for a PS/2 mouse. Once the monitoring pad assembly 400 has properly oriented the pointer 414 on-screen, the computer user may indicate selection of an operation, for example, by depressing a button on a laptop computer.

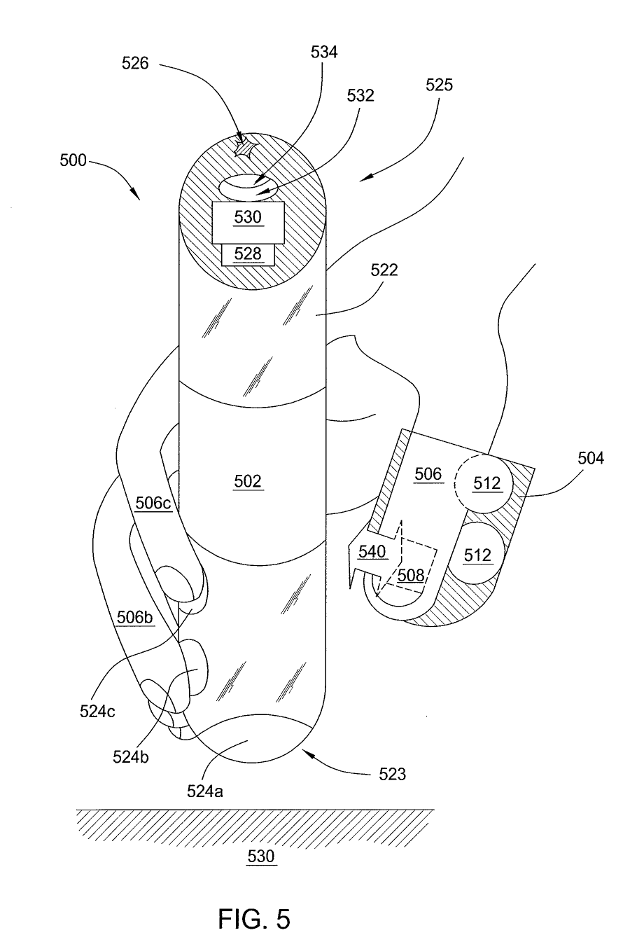

FIG. 5 illustrates a third embodiment of a monitoring pad assembly 500 according to the present invention. The pad assembly 500 includes a signal assembly 504 adapted to be worn over at least one of a user's digits 506, such as the signal assembly 104 described with reference to FIG. 1. The monitoring pad assembly 500 further includes an optical monitoring IC pad 502 that is integrated into a hand-held pad housing 522. In one embodiment, the pad housing 522 is substantially tubular and resembles a pen or laser pointer. One single chip IC that may be advantageously adapted for use in the optical pad 502 of the present invention is the HDNS-2000.

When the LED 508 that is incorporated in the signal assembly 504 is brought into physical contact with the optical monitoring pad 502 on the monitoring pad housing 522, the weight of the digit 506 on which the signal assembly 504 is worn activates a spring switch 540 in the signal assembly 504, activating the LED 508 and causing the LED 508 to emit a beam of light. Conversely, when the user's digit 506 is removed from the monitoring pad 502, the weight of the LED 508 is shifted off of the spring switch 540, breaking the circuit that activates the LED 508 and causing the LED 508 to shut off to save battery power.

The optical monitoring pad 502 is substantially similar to that described in FIG. 1 and includes a digital signal processor (DSP) that converts incremental position changes of the emitted beam of light between a first touch point and a second touch point into distance (ΔX and ΔY) and direction [tan⁻¹ (ΔY/ΔX)] outputs. Thus as the beam of light is sensed and monitored by the optical pad 502, the on-screen pointer is moved according to the movement of the user's digit(s) 506. The algorithm by which the DSP carries out this process is detailed in FIG. 2.

The incorporation of the IC optical pad 502 into a substantially tubular housing 522 allows a user to rotate the optical pad 502, held within his or her hand, relative to the signal assembly 504 worn on the user's digit 506. This allows greater versatility in positioning of the on-screen pointer. Alternatively, the housing 522 may be held steady while the signal assembly 504 is worn on the user's thumb for greater range of motion relative to the optical pad 502.

The monitoring pad housing 522 optionally includes at least one selection button 524 (hereinafter collectively referred to as button(s) 524) similar to those incorporated in a conventional mouse (i.e., left click, middle click and right click). A first end 523 of the pad housing 522 includes a first button 524a, a second button 524b located adjacent the first button 524a and third button 524c located adjacent the second button 524b. Although the embodiment illustrated depicts a monitoring pad assembly 500 having three selection buttons 524, it will be appreciated that less or more buttons 524 may be used to advantage depending upon, for example, the hardware and operating system with which the monitoring pad assembly 500 interacts or the number or nature of appendages 506 used to control the monitoring pad assembly 500. In the embodiment illustrated in FIG. 5, the first button 524a is adapted to enable “left click” functions (i.e., functions enabled by a left mouse button on a conventional mouse), the second button 524b is adapted to enable “middle click” functions (i.e., functions enabled by a middle mouse button on a conventional mouse), and the third button 524c is adapted to enable “right click” functions (i.e., functions enabled by a right mouse button on a conventional mouse). For example, in the embodiment illustrated, the first button 524a is activated by pressing the pad housing 522 against a second surface; the second button 524 b is activated by a user's index finger 506b; and the third button 524c is activated by a user's middle finger 506c. In one embodiment, the buttons 524 are pressure sensors that are activated by depressing a button 524 against a second surface, such as a user finger 506 or palm or a desktop 530. In further embodiments, the buttons may be optical or temperature sensors. Alternatively, existing buttons on, for example, a laptop computer, may be used in conjunction with the monitoring pad assembly 500.

A second end 525 of the pad housing 522 optionally includes a laser pointer 526. The laser pointer 526 includes a power source 528 such as a battery and a momentary switch 530 coupled to a laser diode 532 with a lens 534. The laser pointer 526 emits a beam of light that may be used, for example, for presentation purposes.

The monitoring pad assembly 500 is optionally adapted for remote applications by integrating RF TX/RX into the monitoring pad assembly 500. In one embodiment, integration of RF TX/RX enables remote applications from up to thirty feet away. Alternatively, the output of the IC pad 502 is directly compatible for use with a PS/2 or quadrature detection mouse.

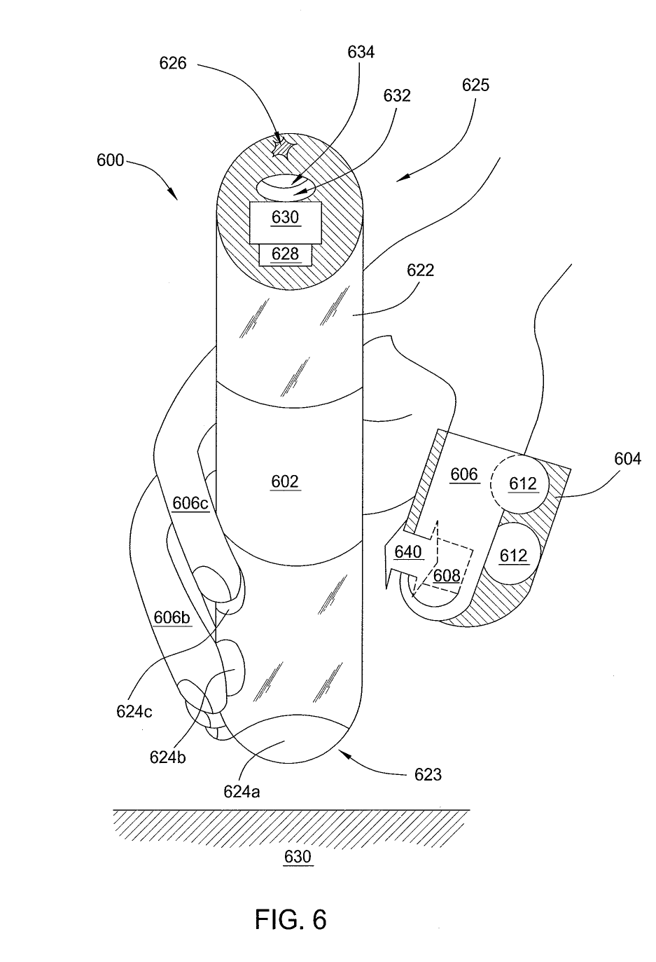

FIG. 6 illustrates a fourth embodiment of the present invention in which a temperature pad 602 and BTT device 608, such as that described in FIG. 4, may be configured similarly to the monitoring pad assembly 500 described in FIG. 5.

The touch pad assembly 600 includes a signal assembly 604 adapted to be worn over at least one of a user's digits 606, such as the signal assembly 504 described with reference to FIG. 5. The monitoring pad assembly 600 further includes a temperature monitoring IC pad 602 that is integrated into a hand-held pad housing 622. In one embodiment, the pad housing 622 is substantially tubular and resembles a pen or laser pointer. Single chip ICs that may be advantageously adapted for use with embodiments of the present invention include the TMP03 and TMP04.

When the BTT 608 that is incorporated in the signal assembly 604 is brought into physical contact with the temperature monitoring pad 602 on the pad housing 622, the weight of the digit 606 on which the signal assembly 604 is worn activates a spring switch 640 in the signal assembly 604, activating the BTT 608 and causing the BTT 608 to emit a temperature signal that emanates from the user (i.e., via body heat). Conversely, when the user's digit 606 is removed from the monitoring pad 602, the weight of the BTT 608 is shifted off of the spring switch 640, breaking the circuit that activates the BTT 608 and causing the BTT 608 to shut off to save battery power.

The temperature monitoring pad 602 is substantially similar to that described in FIG. 4 and includes a digital signal processor (DSP) that converts incremental position changes of the emitted temperature signal between a first touch point and a second touch point into distance (ΔX and ΔY) and direction [tan⁻¹ (ΔY/ΔX)] outputs. Thus as the temperature signal is sensed and monitored by the temperature pad 602, the on-screen pointer is moved according to the movement of the user's digit 606. The algorithm by which the DSP carries out this process is detailed in FIG. 2. The DSP may optionally consist of a separate core built into the temperature pad 602. The temperature sensors in the temperature touch pad 602 may be calibrated to a certain body temperature percentage, so that they are activated only by a signal that meets or exceeds a pre-set temperature. Therefore, inadvertent activation of the monitoring pad assembly 600 may be avoided.

The monitoring pad housing 622 optionally includes at least one selection button 624 (hereinafter collectively referred to as button(s) 724) similar to those incorporated in a conventional mouse (i.e., left click, middle click and right click). A first end 623 of the pad housing 622 includes a first button 624a, a second button 624b located adjacent the first button 624a and third button 624c located adjacent the second button 624b. The buttons 624 are substantially similar in function and in use to the buttons 524 described with reference to the monitoring pad assembly 500 in FIG. 5. In one embodiment, the buttons 624 are pressure sensors that are activated by depressing a button 624 against a second surface, such as a user finger 606 or palm or a desktop 630. In further embodiments, the buttons 624 may be optical or temperature sensors. Alternatively, existing buttons on, for example, a laptop computer, may be used in conjunction with the pointing device.

A second end 625 of the pad housing 622 optionally includes a laser pointer 626. The laser pointed 626 includes a power source 628 such as a battery and a momentary switch 630 coupled to a laser diode 632 with a lens 634. The laser pointer 626 emits a beam of light that may be used, for example, for presentation purposes.

The monitoring pad assembly 600 is optionally adapted for remote applications by integrating RF TX/RX into the device. In one embodiment, integration of RF TX/RX enables remote applications from up to thirty feet away. Alternatively, the output of the IC pad is directly compatible for use with a PS/2 or quadrature detection mouse.

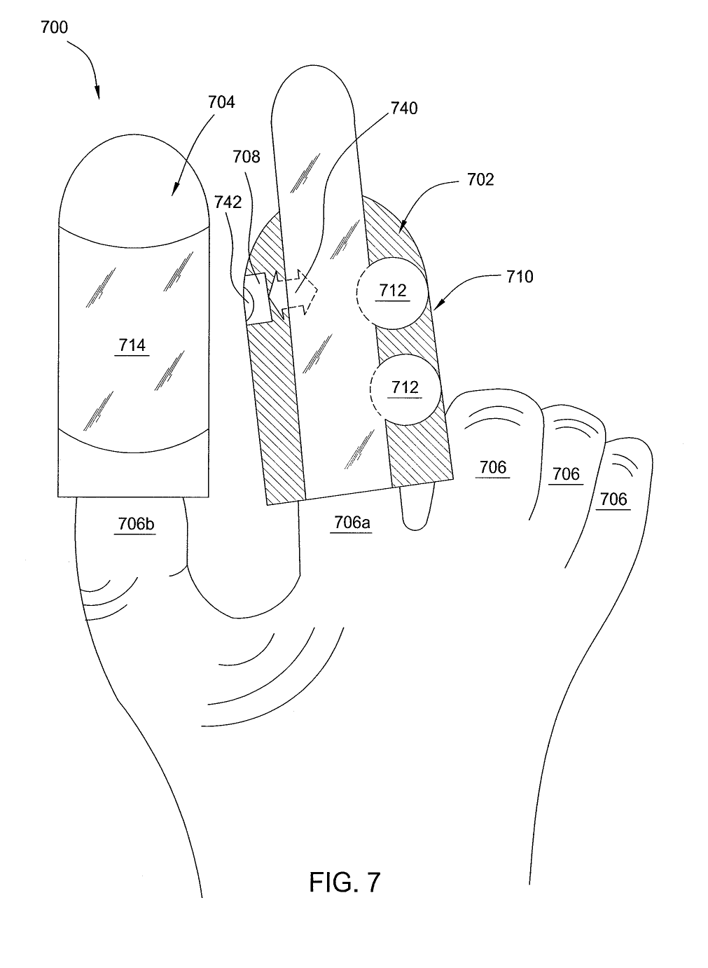

A fifth embodiment of a monitoring pad assembly 700 according to the present invention is illustrated in FIG. 7. The monitoring pad assembly 700 includes a signal assembly 702 adapted to be worn over at least one of user's digits 706 and a monitoring pad housing 704 adapted to be worn over at least one of a user's digits 706.

The signal assembly 702 is substantially similar to that disclosed in FIG. 1 and includes an LED 708 and a power source such as at least one button cell battery 712. In one embodiment, the power source provides between three and five volts to the LED 708. In further embodiments, the signal assembly 702 includes a grin lens 742 for collimating the optical output of the LED 708.

The pad housing 704 includes an optical monitoring IC pad 714 such as that described in FIG. 1. The optical monitoring pad 714 is substantially similar to that described in FIG. 1 and includes a digital signal processor (DSP) that converts incremental position changes of the emitted beam of light between a first touch point and a second touch point into distance (ΔX and ΔY) and direction [tan⁻¹ (ΔY/ΔX)] outputs. Thus as the beam of light is sensed and monitored by the optical pad 714, the on-screen pointer is moved according to the movement of the user's digit(s) 706 on which the signal assembly 702 and pad housing 704 are worn. The algorithm by which the DSP carries out this process is detailed in FIG. 2.

When the LED 708 incorporated into the signal assembly 702 is brought into physical contact with the optical monitoring pad 714 on the pad housing 704, the weight of the digit 706a on which the signal assembly 702 is worn activates a spring switch 740 in the signal assembly 702 that activates the LED 708, causing the LED 708 to emit a beam of light. Conversely, when the user's digit 706a is removed from the monitoring pad 714, the weight of the LED 708 shifts of off the spring switch 740 and breaks the circuit that activates the LED 708, causing the LED 708 to shut off to save battery power.

The incorporation of the IC optical pad 714 into a substantially tubular pad housing 704 adapted to be worn on at least one of a user's digits 706 allows a user to easily rotate the optical pad 714 relative to the LED 708 worn on another of the user's digits 706. This allows greater versatility in positioning of the on-screen pointer.

The monitoring pad assembly 700 may optionally be adapted for remote applications by integrating RF TX/RX into the device. In one embodiment, integration of RF TX/RX enables remote applications from up to thirty feet away. Alternatively, the output of the IC pad 714 is directly compatible for use with a PS/2 or quadrature detection mouse.

Once the monitoring pad assembly 700 has properly oriented the pointer on-screen, the computer user may indicate selection of an operation, for example, by depressing a button on a laptop computer.

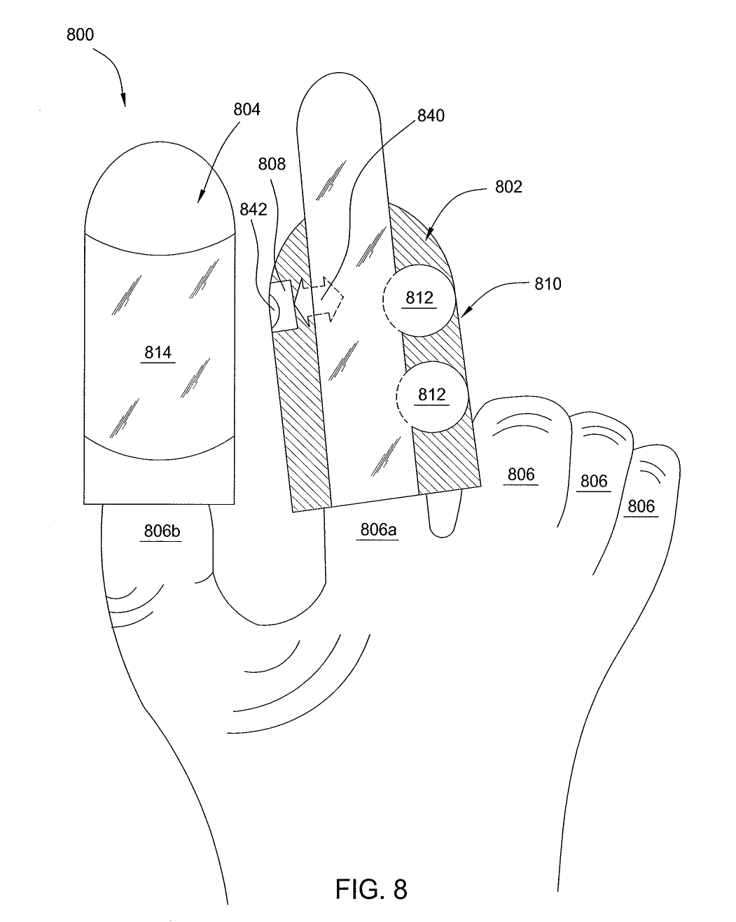

A sixth embodiment of a monitoring pad assembly 800 according to the present invention is illustrated in FIG. 8. The monitoring pad assembly 800 is substantially similar to that described in FIG. 7, except that the signal assembly 802 incorporates a BTT 808 rather than an LED, and the pad housing 804 incorporates a temperature monitoring IC pad 814 rather than an optical monitoring pad. The temperature monitoring pad 814 cooperates with the BTT 808 to move a pointer or icon on-screen.

The signal assembly 802 is substantially similar to that disclosed in FIG. 6 and includes a BTT 808 and a power source such as at least one button cell battery 812. In one embodiment, the power source provides between three and five volts to the BTT 808. In further embodiments, the signal assembly 802 includes a fine tip 842 for collimating the thermal output of the BTT 808.

The pad housing 804 includes a temperature monitoring IC pad 814 such as that described in FIG. 6. The temperature monitoring pad 814 is substantially similar to that described in FIG. 6 and includes a digital signal processor (DSP) that converts incremental position changes of the emitted temperature signal between a first touch point and a second touch point into distance (ΔX and ΔY) and direction [tan⁻¹ (ΔY/ΔX)] outputs. The DSP may optionally consist of a separate core built into the temperature pad 814. The temperature sensors in the temperature touch pad 814 may be calibrated to a certain body temperature percentage, so that they are activated only by a signal that meets or exceeds a pre-set temperature. Therefore, inadvertent activation of the touch pad assembly 800 may be avoided.

The touch pad assembly 800 is optionally adapted for remote applications by integrating RF TX/RX into the monitoring pad assembly 800. In one embodiment, integration of RF TX/RX enables remote applications from up to thirty feet away. Alternatively, the output of the IC pad 814 can be directly adapted for either a standard PS/2 (three button) mode or a two-channel quadrature (X and Y direction) mode.

Once the monitoring pad assembly 800 has properly oriented the pointer on-screen, the computer user may indicate selection of an operation, for example, by depressing a button on a laptop computer or by using a separate device to indicate a selection signal.

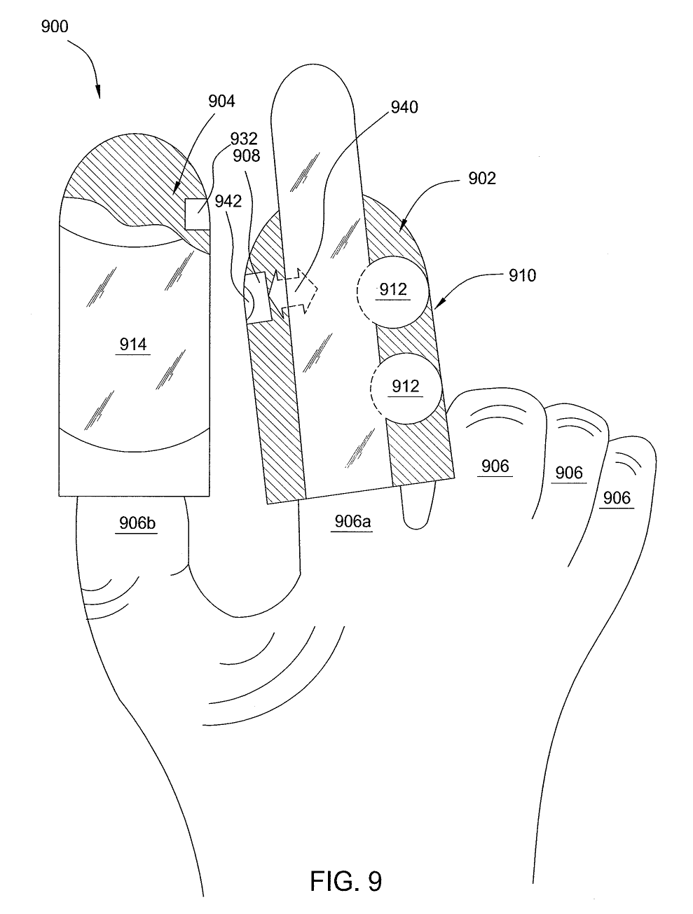

A seventh embodiment of a monitoring pad assembly 900 according to the present invention is illustrated in FIG. 9. The monitoring pad assembly 900 is substantially similar to the device disclosed in FIG. 8 and includes a signal assembly 902 and a monitoring pad housing 904, each adapted to be worn on at least one of user's digits 906.

The signal assembly 902 incorporates a select body temperature tip (SBTT) 908, a temperature selection switch 928 and a peltier cooler 930. The switch 928 is coupled to the SBTT to set a select temperature, and the peltier cooler 930 is coupled to the SBTT 908 by a closed loop circuit. A select temperature value is set for the SBTT output, and the SBTT temperature is regulated and maintained by the closed loop with the peltier cooler 930. The peltier cooler 930 may become a heat sink or a heat source depending on the direction of current flow. This is well established commercial technology used in laser diode temperature control to control, for example, laser central wavelength and power. One peltier cooler that may be advantageously adapted for use with the present invention is the MC1000, commercially available from Swiftech of Signal Hill, Calif. In addition, the signal assembly 902 includes a power source such as at least one button cell battery 912 to power the SBTT 908 and peltier cooler 930. Optionally, a fine tip 942 may be incorporated into the signal assembly 902 to collimate thermal output from the SBTT 908 for greater resolution per square inch.

The pad housing 904 incorporates a select temperature monitoring IC pad 914 that includes select temperature sensors and a peltier cooler 932. Select temperature sensors that may be advantageously adapted for use in the monitoring pad 914 include the TMP03 and TMP04. One. IC that may be advantageously adapted for use with the monitoring pad 914 is the HT6523. The temperature monitoring pad 914 includes a digital signal processor (DSP) that converts incremental position changes of the emitted temperature signal between a first touch point and a second touch point into distance (ΔX and ΔY) and direction [tan⁻¹ (ΔY/ΔX)] outputs. The DSP may optionally consist of a separate core built into the temperature pad 914. The temperature sensors in the temperature monitoring pad 914 may be calibrated to a certain select temperature percentage, so that they are activated only by a signal that meets or exceeds a pre-set temperature. Therefore, inadvertent activation of the touch pad assembly 900 by thermal conditions in the exterior environment may be avoided.

When the SBTT 908 incorporated into the signal assembly 902 is brought into physical contact with the select temperature monitoring pad 914 on the pad housing 904, the weight of the digit 906a on which the signal assembly 902 is worn activates a spring switch 940 on the signal assembly 902, activating the SBTT 908 and causing the SBTT 908 to emit a temperature signal that emanates from the user (i.e., via body heat). Conversely, when the user's digit 906a is removed from the monitoring pad 914, the weight of the SBTT 908 is shifted off of the spring switch 940, breaking the circuit that activates the SBTT 908 and causing the SBTT 908 to shut off to save battery power. The select temperature set for the SBTT 908 and select temperature pad 914 may have a built in margin to allow for deviation from the set select temperature due to, for example, external environmental conditions. For example, if the SBTT 908 is set to emit a signal for an output of 105 degrees Fahrenheit, the select temperature of the IC pad 914 for positioning may be set to 105 degrees+/−10 degrees Fahrenheit.

Thus, the present invention represents a significant advancement in the field of computer usage and computer pointing devices. A monitoring pad assembly is provided in which the problems associated with static charge build up on existing touch pad assemblies are substantially reduced or eliminated. The monitoring pad assembly uses optical or thermal sensors to improve accuracy and functionality in moving a pointer or icon on a computer monitor screen. At least a portion of the assembly is adapted to be worn on at least one of a user's digits, reducing the likelihood of a repetitive motion injury such as those attributed to the use of conventional pointing devices. The monitoring pad assembly is ambidextrous and suitable for use by left- or right-handed users without modification or manufacturing alteration. Furthermore, embodiments of the invention are more versatile than existing touch pad assemblies, making them compatible for desktop, laptop, palmtop and remote applications in a variety of environments.

While the foregoing is directed to embodiments of the invention, other and further embodiments of the invention may be devised without departing from the basic scope thereof, and the scope thereof is determined by the claims that follow.

What is claimed is:

1. A monitoring pad assembly for enabling a user to control a computer displayed pointer, comprising:
a signal assembly adapted to be worn on at least one digit of the user; and
a monitoring pad adapted to be worn by or held by the user, wherein the monitoring pad is adapted to monitor at least one of a thermal signal and an optical signal emitted from the signal assembly;
wherein movement of the signal assembly relative to the monitoring pad indicates a desired movement of the pointer on a display screen.

2. The monitoring pad assembly of claim 1, wherein, when the monitoring pad is adapted to be worn by the user, the monitoring pad is adapted to be worn on at least one digit of the user.

3. The monitoring pad assembly of claim 1, wherein, when the monitoring pad is adapted to be worn by the user, the signal assembly and the monitoring pad are adapted to be worn on the same hand of the user.

4. The monitoring pad assembly of claim 1, wherein, when the monitoring pad is adapted to be held by the user, the monitoring pad is adapted to be held in a hand of the user.

5. The monitoring pad assembly of claim 1, wherein monitoring pad is adapted to be held in a hand of the user on which the signal assembly is worn.

6. The monitoring pad assembly of claim 1, wherein the monitoring pad is integrated into a housing.

7. The monitoring pad assembly of claim 6, wherein the housing is adapted to send a signal to a processor.

8. The monitoring pad assembly of claim 6, wherein the housing further comprises a switch adapted to enable selecting functions.

9. The monitoring pad assembly of claim 8, wherein the switch is a spring switch, wherein:
when the signal-emitting device is brought into contact with the monitoring pad, the weight of the at least one digit on which the signal assembly is worn activates the signal-emitting device; and
when the signal-emitting device is removed from the monitoring pad, removal of the weight of the at least one digit on which the signal assembly is worn deactivates the signal-emitting device.

10. The monitoring pad assembly of claim 6, wherein the housing further comprises a laser pointer adapted to emit a beam of light.

11. The monitoring pad assembly of claim 1, wherein the signal assembly comprises:
a signal-emitting device.

12. The monitoring pad assembly of claim 11, wherein the signal-emitting device is a light-emitting diode.

13. The monitoring pad assembly of claim 12, wherein the signal assembly comprises a grin lens positioned to collimate optical output from the light-emitting diode.

14. The monitoring pad assembly of claim 11, wherein the signal-emitting device is a body temperature tip.

15. The monitoring pad assembly of claim 14, wherein the signal assembly further comprises a fine tip positioned to collimate thermal output from the body temperature tip.

16. The monitoring pad assembly of claim 14, wherein the body temperature tip is a select body temperature tip.

17. The monitoring pad assembly of claim 16, wherein the signal assembly further comprises a peltier cooler coupled to the select body temperature tip by a closed loop circuit.

18. An apparatus for enabling a user to control a computer displayed pointer, comprising:
means for emitting a signal, wherein the signal is one of a thermal signal and an optical signal, wherein the emitting means is adapted to be worn on at least one digit of the user; and
means for monitoring the emitted signal, wherein the monitoring means is adapted to be worn by or held by the user;
wherein movement of the signal assembly relative to the monitoring pad indicates a desired movement of the pointer on a display screen.

19. A method for enabling a user to control a computer displayed pointer, comprising:
receiving, at a monitoring pad adapted to be worn by or held by the user, a signal from a signal assembly adapted to be worn on at least one digit of the user; and
generating, in response to the signal, a position control signal adapted to produce a desired movement of the pointer on a display screen.

20. A monitoring pad assembly for enabling a user to control a computer displayed pointer, comprising:
a signal assembly adapted to be worn on at least one digit of the user; and
a monitoring pad adapted to monitor at least one of a thermal signal and an optical signal emitted from the signal assembly, wherein the monitoring pad is integrated into a computer keyboard;
wherein movement of the signal assembly relative to the monitoring pad indicates a desired movement of the pointer on a display screen.
